(19) United States
(12) Patent Application Publication
(10) Pub. No.: US 2026/0106539 A1
(43) Pub. Date: Apr. 16, 2026

(54) POWER SUPPLY WITH EMI SUPPRESSION

(71) Applicant: Delta Electronics, Inc., Taoyuan City (TW)

(72) Inventors: Shang-Kay Yang, Taoyuan City (TW); Hsien-Kai Wang, Taoyuan City (TW); Yen-Wei Lin, Taoyuan City (TW); Hsing-Yi Chung, Taoyuan City (TW)

(21) Appl. No.: 19/418,765

(22) Filed: Dec. 12, 2025

Related U.S. Application Data
(63) Continuation of application No. 18/523,802, filed on Nov. 29, 2023, now Pat. No. 12,525,876.

(30) Foreign Application Priority Data
Aug. 23, 2023 (CN) 202311066342.9

(51) Int. Cl. H02M 1/44; H02M 3/04

(52) U.S. Cl. CPC H02M 1/44; H02M 3/04

(57) ABSTRACT

A power supply includes a first conversion circuit, a second conversion circuit and a controller. The first conversion circuit receives an input voltage to correspondingly output a first output voltage and an output current. The second conversion circuit receives the first output voltage and the output current to correspondingly output a second output voltage and a load current. The controller controls the first conversion circuit to perform an EMI suppression operation when the first conversion circuit receives a DC voltage. When the first conversion circuit performs the EMI suppression operation and the load current is greater than a preset current and lower than an upper current limit, the controller controls the first conversion circuit to adjust the first output voltage so that a peak-peak value of the first output voltage is not zero as the load current varies between the preset current and the upper current limit.

### CROSS-REFERENCE TO RELATED APPLICATION

This application is a continuation of and claims priority to U.S. patent application Ser. No. 18/523,802, filed on November 29, 2023, titled “EMI suppression method”, which claims priority to Chinese Patent Application No. 202311066342.9, filed on August 23, 2023, the entire content of the above applications is incorporated herein by reference for all purposes.

### FIELD OF THE INVENTION

The present disclosure relates to a power supply, and more particularly to the power supply with improved electromagnetic interference (EMI) suppression.

### BACKGROUND OF THE INVENTION

With the rapid development of the information industry, the power supply has played an indispensable role. The input voltage received by the power supply is an AC voltage or a DC voltage. Generally, a power supply comprises two stages, including a first conversion circuit and a second conversion circuit. For example, the second conversion circuit is a resonant conversion circuit.

In case that the first conversion circuit receives the AC voltage, the frequency of the output voltage from the first conversion circuit is twice the frequency of the voltage from the utility power source. For regulating the output voltage from the first conversion circuit, the switching frequency of the second conversion circuit (i.e., the resonant conversion circuit) is changed in the range of ±6 kHz at the rated power. This frequency change is similar to the characteristic of frequency jitter. Due to the characteristics, the frequency of electromagnetic interference generated by the second conversion circuit is evenly distributed in the range of ±6kHz (<150kHz), and the double frequency is distributed in the range of ±12kHz (>150kHz). Consequently, the electromagnetic interference suppression efficacy is enhanced.

In case that the first conversion circuit receives the DC voltage, the frequency of the output voltage from the first conversion circuit does not contain the double frequency of the voltage from the utility power source. Consequently, the switching frequency of the second conversion circuit is slightly changed in the range of ±0.2 kHz. Since the frequency change amount is very small, the frequency of the electromagnetic interference generated by the second conversion circuit will be concentrated at N times the current switching frequency, wherein N is a positive integer. Consequently, there is not the characteristic of frequency jitter. In case that the first conversion circuit receives the DC voltage, the electromagnetic interference suppression efficacy of the power supply is not satisfied.

Therefore, there is a need of providing an improved electromagnetic interference suppression method in order to overcome the drawbacks of the conventional technologies.

### SUMMARY OF THE INVENTION

The present disclosure provides an electromagnetic interference suppression method for a power supply. In case that the power supply receives a DC input voltage, the electromagnetic interference suppression efficacy can be enhanced when compared with the conventional technologies.

In accordance with an aspect of present disclosure, an embodiment of a power supply comprises a first conversion circuit, receiving an input voltage to correspondingly output a first output voltage and an output current; a second conversion circuit, connected with the first conversion circuit and controlled in a frequency modulation manner for receiving the first output voltage and the output current to correspondingly output a second output voltage and a load current; and at least one controller, controlling the first conversion circuit to perform an electromagnetic interference (EMI) suppression operation when the input voltage received by the first conversion circuit is a DC voltage, wherein when the first conversion circuit performs the EMI suppression operation and the load current is greater than a preset current and lower than an upper current limit, the controller controls the first conversion circuit to adjust the first output voltage so that a peak-peak value of the first output voltage is not zero as the load current varies between the preset current and the upper current limit.

In accordance with another aspect of present disclosure, an embodiment of a plurality parallelly connected power supplies with input terminals electrically connected with each other comprises at least N power supplies (N is an integer >= 2), each of which comprising: a first conversion circuit, receiving an input voltage to correspondingly output a first output voltage and an output current; a second conversion circuit, connected with the first conversion circuit and controlled in a frequency modulation manner for receiving the first output voltage and the output current to correspondingly output a second output voltage and a load current; and at least one controller, controlling the first conversion circuit to perform an electromagnetic interference suppression operation when the input voltage received by the first conversion circuit is a DC voltage, wherein when the first conversion circuit performs the EMI suppression operation and the load current is greater than a preset current and lower than an upper current limit, the controller controls the first conversion circuit to adjust the first output voltage so that a peak-peak value of the first output voltage is not zero as the load current varies between the preset current and the upper current limit; wherein when the N first conversion circuits of the N power supplies provide the N first output voltages, at least a phase difference exists between two of the N first output voltages.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a flowchart of an electromagnetic interference suppression method according to an embodiment of the present disclosure;

FIG. 2 is a schematic circuit block diagram illustrating a power supply using the electromagnetic interference suppression method of FIG. 1;

FIG. 3 is a characteristic curve of the power supply using the electromagnetic interference suppression method of the present disclosure, in which the first output voltage is changed, and the peak-peak value of the first output voltage is not changed with the varying load current;

FIG. 4 is a characteristic curve of the power supply using the electromagnetic interference suppression method of the present disclosure, in which the first output voltage is changed, and the peak-peak value of the first output voltage is changed with the varying load current;

FIG. 5 schematically illustrates the architecture of a power system with a plurality of power supplies;

FIG. 6 is a schematic timing waveform diagram illustrating first output voltage, the output current and the current total of the power supply, in which there is a phase difference between the two first output voltages from two first conversion circuits of two power suppliers; and

FIG. 7 is a schematic timing waveform diagram illustrating associated voltages and currents from the first conversion circuits of a power system with two power supplies.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

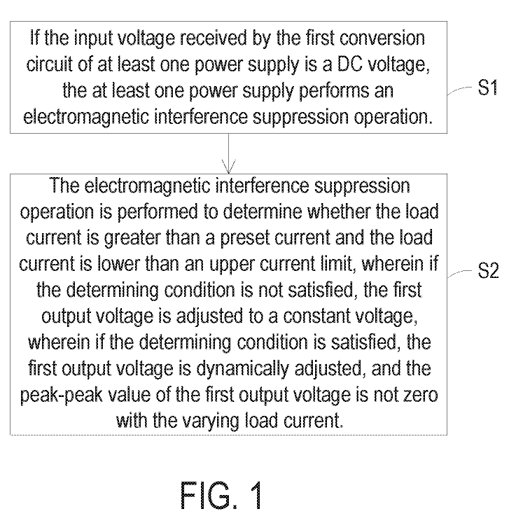

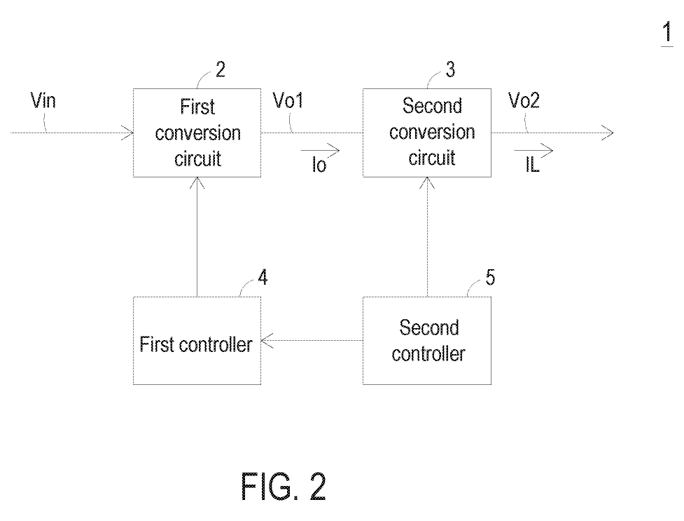

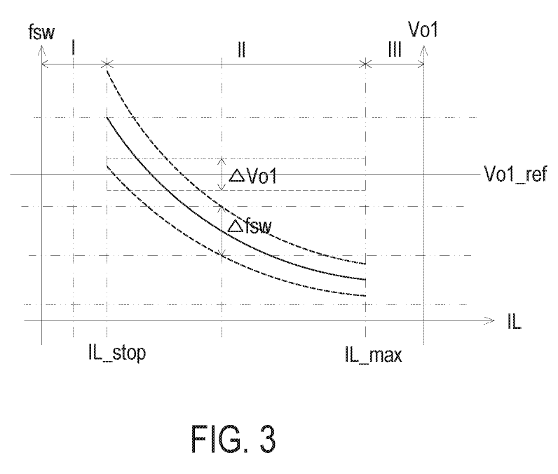

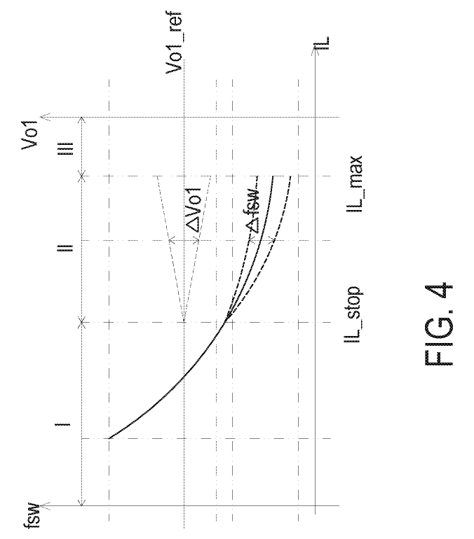

FIG. 1 is a flowchart of an electromagnetic interference suppression method according to an embodiment of the present disclosure. FIG. 2 is a schematic circuit block diagram illustrating a power supply using the electromagnetic interference suppression method of FIG. 1. FIG. 3 is a characteristic curve of the power supply using the electromagnetic interference suppression method of the present disclosure, in which the first output voltage is changed, and the peak-peak value of the first output voltage is not changed with the varying load current. FIG. 4 is a characteristic curve of the power supply using the electromagnetic interference suppression method of the present disclosure, in which the first output voltage is changed, and the peak-peak value of the first output voltage is changed with the varying load current.

The electromagnetic interference suppression method of the present disclosure can be applied to the power supply 1 as shown in FIG. 2. The power supply 1 includes a first conversion circuit 2 and a second conversion circuit 3. The first conversion circuit 2 receives an input voltage Vin, and the first conversion circuit 2 outputs a first output voltage Vo1 and an output current Io. The second conversion circuit 3 is controlled in a frequency modulation manner. In addition, the second conversion circuit 3 receives the first output voltage Vo1 and the output current Io, and the second conversion circuit 3 outputs a load current IL and a second output voltage Vo2. In other words, the first output voltage Vo1 from the first conversion circuit 2 is served as the input voltage of the second conversion circuit 3, and the output current Io from the first conversion circuit 2 is served as the input current of the second conversion circuit 3.

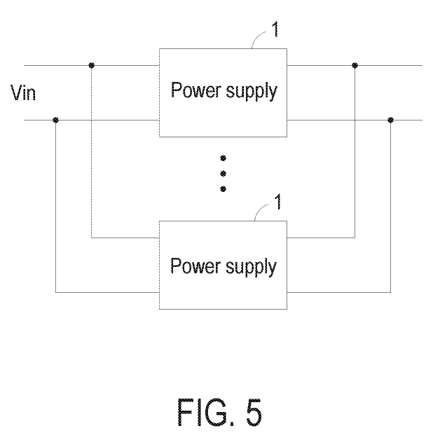

FIG. 5 schematically illustrates the architecture of a power system with a plurality of power supplies. The electromagnetic interference suppression method of the present disclosure is also applied to a power system with a plurality of power supplies 1. The plurality of power supplies 1 are connected with each other in parallel. The circuitry topology of each of the plurality of power supplies is similar to the circuitry topology as shown in FIG. 2, and not redundantly described herein.

The input terminals of the plurality of power supplies 1 are electrically connected with each other. That is, the input terminals of the plurality of first conversion circuits 2 of the plurality of power supplies are connected with each other. Moreover, the output terminals of the plurality of power supplies 1 are electrically connected with each other. That is, the output terminals of the plurality of second conversion circuits 3 of the plurality of power supplies 1 are connected with each other.

Preferably but not exclusively, the first conversion circuit 2 is a boost conversion circuit or a buck conversion circuit, and the second conversion circuit 3 is a resonant conversion circuit (e.g., an LLC resonant conversion circuit or an LCL resonant conversion circuit). Moreover, as shown in FIG. 2, the power supply 1 further includes a first controller 4 and a second controller 5. The first conversion circuit 2 is controlled by the first controller 4. The second conversion circuit 3 is controlled by the second controller 5. In addition, the first controller 4 and the second controller 5 are in communication with each other.

The electromagnetic interference suppression method includes the following steps.

In a step S1, if the input voltage Vin received by the first conversion circuit 2 of at least one power supply 1 is a DC voltage, the at least one power supply 1 performs an electromagnetic interference suppression operation. As mentioned above, the second conversion circuit 3 of the power supply 1 has good electromagnetic interference suppression efficacy when the input voltage Vin is the AC voltage. Consequently, the electromagnetic interference suppression operation is performed only when the input voltage Vin is the DC voltage.

In a step S2, the electromagnetic interference suppression operation is performed to determine whether the load current IL is greater than a preset current IL_stop and lower than an upper current limit IL_max. If the determining result indicates that the load current IL is lower than the preset current IL_stop or greater than the upper current limit IL_max (i.e., the determining condition is not satisfied), the first output voltage Vo1 is adjusted to a constant voltage. That is, the peak-peak value △Vo1 of the first output voltage Vo1 is zero (i.e., the first output voltage Vo1 is equal to a voltage reference value Vo1_ref). If the load current IL is greater than the preset current IL_stop and lower than the upper current limit IL_max (i.e., the determining condition is satisfied), the first output voltage Vo1 is dynamically adjusted, and the peak-peak value of the first output voltage Vo1 is not zero with the varying load current IL.

Of course, the step S2 may be altered according to the practical requirements. In another embodiment, if the load current IL is greater than the preset current IL_stop and lower than the upper current limit IL_max (i.e., the determining condition is satisfied), the peak-peak value △Vo1 of the first output voltage Vo1 is adjusted to a constant value with the varying load current IL. Alternatively, if the determining condition is satisfied, the peak-peak value △Vo1 of the first output voltage Vo1 is linearly changed with the varying load current IL.

In this context, the zero value of the peak-peak value △Vo1 of the first output voltage Vo1 indicates that the peak-peak value △Vo1 is zero in the ideal condition. However, since the first conversion circuit 2 is a switching conversion circuit, the first output voltage Vo1 may contain tiny ripple even if it is adjusted to the constant voltage. The tiny ripple will be ignored.

The principles of the electromagnetic interference suppression method and the operations of the step S2 will be described in more details as follows.

If the input voltage Vin is the DC voltage, the first output voltage Vo1 from the first conversion circuit 2 is controlled to be changed. Consequently, the input voltage received by the second conversion circuit 3 is correspondingly adjusted. If the load current IL is increased, the first output voltage Vo1 is controlled to be increased. If the load current IL is decreased, the first output voltage Vo1 is controlled to be decreased. Moreover, the output terminal of the first conversion circuit 2 is connected with the input terminal of the second conversion circuit 3. Moreover, the second conversion circuit 3 is controlled in the frequency modulation manner, and the input voltage received by the second conversion circuit 3 (i.e., the first output voltage Vo1) is influenced by the change of the input voltage. In order to adjust the second output voltage Vo2 to a constant value, the switching frequency fsw of the second conversion circuit 3 is correspondingly adjusted. If the variation amount of the first output voltage Vo1 is larger, the change of the switching frequency fsw is also larger. Whereas, if the variation amount of the first output voltage Vo1 is smaller, the switching frequency fsw is smaller.

In accordance with the electromagnetic interference characteristics of any conversion circuit (including the resonant conversion circuit), the following conditions can be observed. That is, if the loading is increased, the N-order harmonic energy generated by the conversion circuit is increased. Whereas, if the loading is decreased, the N-order harmonic energy generated by the conversion circuit is decreased.

Due to these physical characteristics, the electromagnetic interference specification about the limitation of the harmonic energy will be deduced. If the loading is increased, the generated harmonic energy is increased and close to the upper limit value. Whereas, if the loading is decreased, the generated harmonic energy is decreased and far away from the upper limit value. Due to the electromagnetic interference between the first output voltage Vo1 of the first conversion circuit 2 and the second conversion circuit 3, the first output voltage Vo1 outputted from the first conversion circuit 2 is adjusted according to the different loading conditions. If the loading is increased, the generated harmonic energy is increased. In order to comply with the specifications, the variation amount of the first output voltage Vo1 from the first conversion circuit 2 needs to be increased. Whereas, if the loading is decreased, the generated harmonic energy is decreased. Consequently, the variation amount of the first output voltage Vo1 from the first conversion circuit 2 is decreased or kept unchanged.

In an embodiment of the step S2, the first output voltage Vo1 is dynamically changed, and the peak-peak value△Vo1 of the first output voltage Vo1 is maintained at the constant value with the varying load current IL. As shown in FIG. 3, the power supply 1 can be operated in three operating zones. These operating zones include a first operating zone, a second operating zone and a third operating zone. In the first operating zone, the load current IL is lower than the preset current IL_stop. For example, the preset current IL_stop is equal to the minimum value of the load current IL when the harmonic energy generated by the power supply is within the limitation of the regulations. In the first operating zone, the first output voltage Vo1 from the first conversion circuit 2 is adjusted to the constant voltage. Moreover, in the second operating zone, the load current IL is greater than the preset current IL_stop and lower than the upper current limit IL_max. Moreover, in the second operating zone, the first output voltage Vo1 form the first conversion circuit 2 is dynamically changed, and the peak-peak value △Vo1 of the first output voltage Vo1 is constant with the varying load current IL. Moreover, since the corresponding peak-peak value △Vo1 is constant with the varying load current IL, the variation amount △fsw of the switching frequency fsw of the second conversion circuit 3 is constant with the varying load current IL. In the third operating zone, the load current IL is greater than the upper current limit IL_max. Preferably but not exclusively, the upper current limit IL_max is the maximum rated output current of the power supply 1. Moreover, in the third operating zone, the first output voltage Vo1 form the first conversion circuit 2 is adjusted to the constant voltage.

In another embodiment of the step S2, the first output voltage Vo1 is dynamically changed, and the peak-peak value △Vo1 of the first output voltage Vo1 is changed linearly with the varying load current IL. As shown in FIG. 4, the power supply 1 includes three operating zones. These operating zones include a first operating zone, a second operating zone and a third operating zone. The operating conditions and the control methods of the power supply 1 in the first operating zone and the third operating zone as shown in FIG. 4 are similar to those as shown in FIG. 3, and not redundantly described herein. Please refer to FIG. 4. In the second operating zone, the load current IL is greater than the preset current IL_stop and lower than the upper current limit IL_max. Moreover, in the second operating zone, the first output voltage Vo1 from the first conversion circuit 2 is dynamically changed, and the peak-peak value △Vo1 of the first output voltage Vo1 is changed linearly with the varying load current IL. Since the peak-peak value △Vo1 of the first output voltage Vo1 is changed linearly with the varying load current IL, the variation amount △fsw of the switching frequency fsw of the second conversion circuit 3 is changed linearly with the varying load current IL. In an embodiment, the peak-peak value ΔVo1 of the first output voltage Vo1 is equal to the difference between the load current IL and the preset current IL_stop multiplied by a fixed value K, i.e., ΔVo1 = (IL - IL_stop)×K.

From the above descriptions, the present disclosure provides the electromagnetic interference suppression method. In case that the input voltage Vin received by the first conversion circuit 2 of the power supply 1 is the DC voltage, the power supply 1 performs the electromagnetic interference suppression operation. If the load current IL is greater than the preset current IL_stop and lower than the upper current limit IL_max, the first output voltage Vo1 is dynamically changed, and the peak-peak value △Vo1 of the first output voltage Vo1 is not zero with the varying load current IL. For example, the peak-peak value △Vo1 of the first output voltage Vo1 is kept unchanged with the varying load current IL. Alternatively, the peak-peak value △Vo1 of the first output voltage Vo1 is changed linearly with the varying load current IL. Under this circumstance, the electromagnetic interference suppression efficacy can be enhanced. Whereas, if the load current IL is lower than the preset current IL_stop or greater than the upper current limit IL_max, the electromagnetic interference suppression is not required. Consequently, the first output voltage Vo1 is kept unchanged. In this way, the electromagnetic interference suppression efficacy of the power supply 1 can be enhanced.

In an embodiment, the second controller 5 detects the magnitude of the load current IL, and the detecting result is provided to the first controller 4. Moreover, the first output voltage Vo1 from the first conversion circuit 2 is controlled by the first controller 4 according to a voltage reference value Vo1_ref in the detecting result. For example, the voltage reference value Vo1_ref is shown in FIG. 3 or FIG. 4.

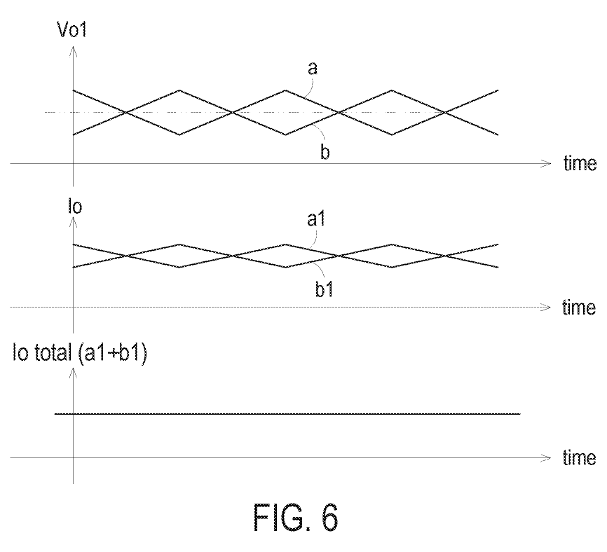

FIG. 6 is a schematic timing waveform diagram illustrating first output voltage, the output current and the current total of the power supply, in which there is a phase difference between the two first output voltages from two first conversion circuits of two power suppliers. In an embodiment, the electromagnetic interference suppression method is applied to the plurality of power supplies 1 of the power system as shown in FIG. 5. The plurality of power supplies 1 are in communication with each other through an external controller (not shown) or the internal controllers of the plurality of power supplies 1. Consequently, there is a phase difference between the variation amounts of the first output voltages Vo1 from the first conversion circuits 2 of every two power supplies 1. Correspondingly, there is the phase difference between the current ripples in the output currents Io from the first conversion circuits 2 of the plurality of power supplies 1. Consequently, the current ripples cancel out each other. Due to this design, the ripple in the superimposed output currents from the plurality of parallel-connected power suppliers 1 will not be too large.

In an embodiment, the power system includes N power supplies. Moreover, the phase difference between the first output voltages Vo1 from the first conversion circuits 2 of every two adjacent power supplies 1 is 360°/N.

Please refer to FIG. 6. In case that the electromagnetic interference suppression method is applied to a power system comprising two power supplies 1, the phase difference between the first output voltage Vo1 of one power supply 1 (e.g., the curve a) and the first output voltage Vo1 from the other power supply 1 (e.g., the curve b) is 360°/2 = 180°. Correspondingly, the phase difference between the output current Io from one power supply 1 (e.g., the curve a1) and the output current Io from the other power supply 1 (e.g., the curve b1) is also 180°. Under this circumstance, the current ripples in the two output currents will cancel out each other. That is, as shown in FIG, 6, there is almost no current ripple in Io total (i.e., a1+b1).

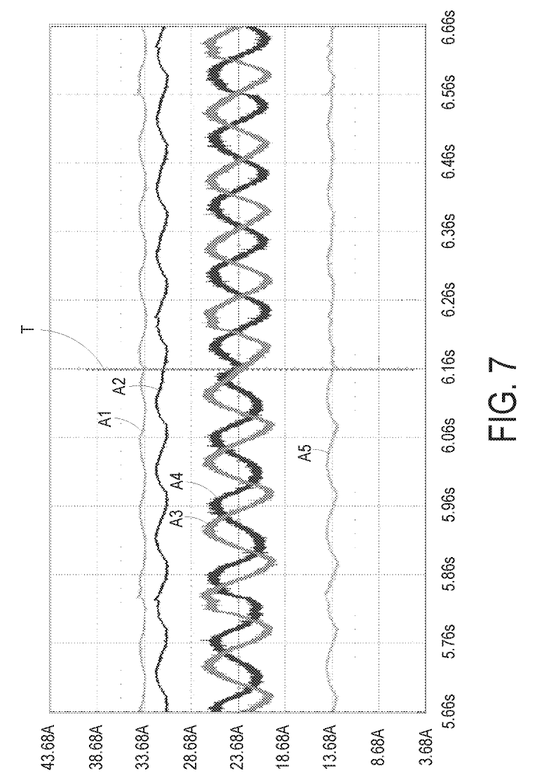

FIG. 7 is a schematic timing waveform diagram illustrating associated voltages and currents from the first conversion circuits of a power system with two power supplies. For example, the power system includes a first power supply 1 and a second power supply 1. The first power supply 1 and the second power supply 1 are connected with each other in parallel.

The curve A1 denotes the waveform of the output current Io from the first conversion circuit 2 of the first power supply 1. The curve A2 denotes the waveform of the output current Io from the first conversion circuit 2 of the second power supply 1. The curve A3 denotes the waveform of the first output voltage Vo1 from the first conversion circuit 2 of the first power supply 1. The curve A4 denotes the waveform of the first output voltage Vo1 from the first conversion circuit 2 of the second power supply 1. The curve A5 denotes the combined waveform of the curve A1 and the curve A2. After the time point T, the phase difference between the first output voltages Vo1 from the first conversion circuits 2 of the two power supplies 1 is 180°. Consequently, the current ripples in the output currents Io from the first conversion circuits 2 of the plurality of power supplies 1 cancel out each other.

In some other embodiments, the step S2 of the electromagnetic interference suppression method is modified. The electromagnetic interference suppression operation is performed to determine whether the load current IL is greater than the preset current IL_stop and lower than an upper current limit IL_max. If the load current IL is greater than the preset current IL_stop and lower than the upper current limit IL_max (i.e., the determining condition is satisfied), the first output voltage Vo1 is dynamically adjusted, and the peak-peak value of the first output voltage Vo1 is not zero with the varying load current IL. For example, the peak-peak value △Vo1 of the first output voltage Vo1 is adjusted to a constant value with the varying load current IL. Alternatively, if the determining condition is satisfied, the peak-peak value △Vo1 of the first output voltage Vo1 is linearly changed with the varying load current IL.

From the above descriptions, the present disclosure provides the electromagnetic interference suppression method. If the input voltage received by the first conversion circuit of at least one power supply is a DC voltage, the at least one power supply performs an electromagnetic interference suppression operation. If the determining condition is satisfied, the first output voltage is dynamically adjusted, and the peak-peak value of the first output voltage is not zero with the varying load current. If the determining condition is not satisfied, the first output voltage adjusted to a constant voltage.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power supply, comprising:
a first conversion circuit, receiving an input voltage to correspondingly output a first output voltage and an output current;
a second conversion circuit, connected with the first conversion circuit and controlled in a frequency modulation manner for receiving the first output voltage and the output current to correspondingly output a second output voltage and a load current; and
at least one controller, controlling the first conversion circuit to perform an electromagnetic interference (EMI) suppression operation when the input voltage received by the first conversion circuit is a DC voltage,
wherein when the first conversion circuit performs the EMI suppression operation and the load current is greater than a preset current and lower than an upper current limit, the controller controls the first conversion circuit to adjust the first output voltage so that a peak-peak value of the first output voltage is not zero as the load current varies between the preset current and the upper current limit.

2. The power supply according to claim 1, wherein when the controller determines the load current is lower than the preset current or greater than the upper current limit, the controller controls the first conversion circuit to adjust the first output voltage to be substantially constant so that the peak-peak value of the first output voltage is substantially zero.

3. The power supply according to claim 1, wherein when the controller determines the load current is greater than the preset current and lower than the upper current limit, the controller controls the first conversion circuit to adjust the peak-peak value of the first output voltage to be a constant value as the load current varies between the preset current and the upper current limit.

4. The power supply according to claim 1, wherein when the controller determines the load current is greater than the preset current and lower than the upper current limit, the controller controls the first conversion circuit to adjust the peak-peak value of the first output voltage to be linearly changed as the load current varies between the preset current and the upper current limit.

5. The power supply according to claim 4, wherein the controller controls the first conversion circuit to adjust the peak-peak value of the first output voltage to be linearly changed and proportionally with a difference between the load current and the preset current as the load current varies between the preset current and the upper current limit.

6. The power supply according to claim 1, wherein the controller comprises a first controller for controlling the first conversion circuit, and a second controller for controlling the second conversion circuit.

7. The power supply according to claim 1, wherein the first conversion circuit receives either one of an AC voltage or the DC voltage and correspondingly performs at least one of a boost conversion and a buck conversion.

8. A plurality of parallelly connected power supplies with input terminals electrically connected with each other, comprising:
at least N power supplies (N is an integer >= 2), each of which comprising:
a first conversion circuit, receiving an input voltage to correspondingly output a first output voltage and an output current;
a second conversion circuit, connected with the first conversion circuit and controlled in a frequency modulation manner for receiving the first output voltage and the output current to correspondingly output a second output voltage and a load current; and
at least one controller, controlling the first conversion circuit to perform an electromagnetic interference (EMI) suppression operation when the input voltage received by the first conversion circuit is a DC voltage, wherein when the first conversion circuit performs the EMI suppression operation and the load current is greater than a preset current and lower than an upper current limit, the controller controls the first conversion circuit to adjust the first output voltage so that a peak-peak value of the first output voltage is not zero as the load current varies between the preset current and the upper current limit;
wherein when the N first conversion circuits of the N power supplies provide the N first output voltages, at least a phase difference exists between two of the N first output voltages.

9. The power supplies according to claim 8, wherein the phase difference is 360°/N.

10. The power supplies according to claim 8, wherein when the controller determines the load current is lower than the preset current or greater than the upper current limit, the controller controls the first conversion circuit to adjust the first output voltage to be substantially constant so that the peak-peak value of the first output voltage is substantially zero.

11. The power supplies according to claim 8, wherein when the controller determines the load current is greater than the preset current and lower than the upper current limit, the controller controls the first conversion circuit to adjust the peak-peak value of the first output voltage to be a constant value as the load current varies between the preset current and the upper current limit.

12. The power supplies according to claim 8, wherein when the controller determines the load current is greater than the preset current and lower than the upper current limit, the controller controls the first conversion circuit to adjust the peak-peak value of the first output voltage to be linearly changed as the load current varies between the preset current and the upper current limit.

13. The power supplies according to claim 12, wherein the controller controls the first conversion circuit to adjust the peak-peak value of the first output voltage to be linearly changed and proportionally with a difference between the load current and the preset current as the load current varies between the preset current and the upper current limit.

14. The power supplies according to claim 8, wherein the controller comprises a first controller for controlling the first conversion circuit, and a second controller for controlling the second conversion circuit.

15. The power supplies according to claim 8, wherein the first conversion circuits receive either one of an AC voltage or the DC voltage and correspondingly perform at least one of a boost conversion and a buck conversion.
